(19) United States
(12) Patent Application Publication
(10) Pub. No.: US 2026/0333120 A1
(43) Pub. Date: Oct. 22, 2026

(54) STATUS REPORT GENERATION

(71) Applicant: Lenovo (United States) Inc., Morrisville, NC (US)

(72) Inventors: Joachim Löhr, Wiesbaden (DE); Tapisha Soni, Munich (DE); Prateek Basu Mallick, Dreieich (DE)

(73) Assignee: Lenovo (United States) Inc., Morrisville, NC (US)

(21) Appl. No.: 19/340,528

(22) Filed: Sep. 25, 2025

(51) Int. Cl. H04W 28/02; H04L 5/00; H04L 69/322

(52) U.S. Cl. CPC H04W 28/0278; H04L 5/0055; H04L 69/322

(57) ABSTRACT

Various aspects of the present disclosure relate to status report generation. An apparatus, such as a user equipment (UE), receives a request for a status report and a type of the status report. The UE generates the report in response to the received request and based on the type of the status report, and the UE transmits the report. In some examples, the status report may be a radio link control (RLC) status report that includes acknowledgment (ACK) information and excludes negative acknowledgment (NACK) information, where the ACK information corresponds to one or more RLC protocol data units (PDUs) or RLC service data units (SDUs).

### TECHNICAL FIELD

The present disclosure relates to wireless communications, and more specifically to status report generation.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to receive a request for a status report and a type of the status report; generate the status report in response to the received request, where the status report is based on the type of the status report; and transmit the status report.

A processor (e.g., a standalone processor chipset, or a component of a UE) for wireless communication is described. The processor may be configured to, capable of, or operable to perform one or more operations as described herein. For example, the processor may be configured to, capable of, or operable to receive a request for a status report and a type of the status report; generate the status report in response to the received request, where the status report is based on the type of the status report; and transmit the status report.

A method performed or performable by a UE for wireless communication is described. The method may include receiving a request for a status report and a type of the status report; generating the status report in response to the received request, where the status report is based on the type of the status report; and transmitting the status report.

In some implementations of the UE, the processor, and the method described herein, the type of the status report is a radio link control (RLC) status report, and where the RLC status report includes acknowledgment (ACK) information and excludes negative acknowledgment (NACK) information, and where the ACK information corresponds to one or more RLC protocol data units (PDUs) or RLC service data units (SDUs).

In some implementations of the UE, the processor, and the method described herein, the ACK information includes a sequence number indicating a first partially received or missing RLC PDU or RLC SDU. In some implementations of the UE, the processor, and the method described herein, the RLC status report further includes a bitmap or one or more additional sequence numbers indicating ACK information for one or more non-consecutive RLC PDUs or RLC SDUs.

In some implementations of the UE, the processor, and the method described herein, the received request for the status report includes one or more sequence numbers, the one or more sequence numbers indicative of a request for status information corresponding to one or more respective RLC PDUs or respective RLC SDUs associated with the one or more sequence numbers. In some implementations of the UE, the processor, and the method described herein, respective status information corresponding to a respective RLC PDU or a respective RLC SDU includes one or more of an ACK, a NACK, or unknown.

In some implementations of the UE, the processor, and the method described herein, the RLC status report includes a request for a retransmission of the one or more respective RLC PDUs or respective RLC SDUs. In some implementations of the UE, the processor, and the method described herein, the request is received via an RLC control PCU or an RLC PDU header. In some implementations of the UE, the processor, and the method described herein, the status report is generated based on a timer, where the status report is transmitted irrespective of an expiration of the timer, and where the timer is a t-reassembly timer.

An NE (e.g., a base station, a gNB) for wireless communication is described. The NE may be configured to, capable of, or operable to perform one or more operations as described herein. For example, the NE may be configured to, capable of, or operable to transmit a request for a status report and a type of the status report; and receive the status report, where the status report is based on the type of the status report.

A processor (e.g., a standalone processor chipset, or a component of a NE) for wireless communication is described. The processor may be configured to, capable of, or operable to perform one or more operations as described herein. For example, the processor may be configured to, capable of, or operable to transmit a request for a status report and a type of the status report; and receive the status report, where the status report is based on the type of the status report.

A method performed or performable by an NE (e.g., a base station) for wireless communication is described. The method may include transmitting a request for a status report and a type of the status report; and receiving the status report, where the status report is based on the type of the status report.

In some implementations of the NE, the processor, and the method described herein, the type of the status report is an RLC status report, where the RLC status report includes ACK information and excludes NACK information, and where the ACK information corresponds to one or more RLC PDUs or RLC SDUs.

In some implementations of the NE, the processor, and the method described herein, the ACK information includes a sequence number indicating a first partially received or missing RLC PDU or RLC SDU. In some implementations of the NE, the processor, and the method described herein, the NE, the processor, and the method may further be configured to, capable of, operable to, performed to, or performable to update a transmission window based on the sequence number indicated in the ACK information.

In some implementations of the NE, the processor, and the method described herein, the RLC status report further includes a bitmap or one or more additional sequence numbers indicating ACK information for one or more non-consecutive RLC PDUs or RLC SDUs. In some implementations of the NE, the processor, and the method described herein, the transmitted request for the status report includes one or more sequence numbers, the one or more sequence numbers indicative of a request for status information corresponding to one or more respective RLC PDUs or respective RLC SDUs associated with the one or more sequence numbers.

In some implementations of the NE, the processor, and the method described herein, the RLC status report includes a request for a retransmission of the one or more respective RLC PDUs or respective RLC SDUs. In some implementations of the NE, the processor, and the method described herein, the NE, the processor, and the method may further be configured to, capable of, operable to, performed to, or performable to trigger the retransmission of the one or more respective RLC PDUs or respective RLC SDUs based on the request. In some implementations of the NE, the processor, and the method described herein, respective status information corresponding to a respective RLC PDU or a respective RLC SDU includes one or more of an ACK, a NACK, or unknown.

### BRIEF DESCRIPTION OF THE DRAWINGS

FIG. 1 illustrates an example of a wireless communications system in accordance with aspects of the present disclosure.

FIGS. 2 and 3 illustrate examples of packet data convergence protocol (PDCP) and RLC reception windows in accordance with aspects of the present disclosure.

FIGS. 4 through 6 illustrate examples of status reports in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. An RLC layer may manage the transmission of data between the UE and the NE based on transmitting status reports which indicate received or missing PDUs or SDUs. In some examples, a quick advancing of an RLC transmission window by an RLC transmitter side may be useful to avoid a window stalling. The RLC transmission window may be advanced based on received status reports from an RLC receiver. Some such RLC status reports may provide a status of a complete RLC receiving window, which may include information regarding successfully received SDUs (e.g., ACK information) as well as information on SDUs or segments of SDUs that are not acknowledged or that are unsuccessfully received, thus requiring an RLC retransmission (e.g., NACK information). However, such RLC status reports may be inefficient in a scenario requiring rapid acknowledgment because all of the SDUs that are not acknowledged in the report (e.g., included in the ACK information) are negatively acknowledged. In such cases, a t-Reassembly timer that is running may allow hybrid automatic repeat request (HARQ) retransmissions to finish, where the t-Reassembly timer is used by the RLC receiver to detect the unsuccessfully received PDUs and prevent data from being prematurely retransmitted before the HARQ (re)transmissions have finished. That is, the RLC transmitter may wait until the t-Reassembly timer expires before confirming that a PDU is missing (e.g., to avoid false or premature NACKs), thus delaying ACK reporting.

Aspects of the present disclosure are described in the context of a wireless communications system, and include implementations that provide for status report generation to enable a rapid advancement of an RLC transmission window, which may allow for more efficient window management. As described herein, a UE (e.g., a receiver side of an RLC entity) may generate and transmit status reports to an NE (e.g., a transmitter side of the RLC entity) without waiting for expiration of a timer, such as a t-Reassembly timer. In such cases, the status reports may include ACK-only status reports, or status reports that include ACK information about acknowledged PDUs or SDUs and exclude (e.g., does not include or convey) NACK information about partially-received or missing PDUs or SDUs. Such ACK-only status reports enable the NE to advance its transmission window without expiration of the t-Reassembly timer. In some examples, the NE may explicitly request status information (e.g., ACK information) for one or more specific RLC PDUs or SDUs from the UE or a peer receiving RLC entity. In contrast to 5G NR polling procedures, which request a complete status report for an entire reception window, the NE may transmit a request that selectively indicates particular PDUs or SDUs of interest, for example by identifying the PDUs or SDUs by corresponding sequence numbers.

Specifically, a UE may receive a request for a status report and a type of status report. For example, the request may be for an RLC status report. The UE may generate the status report in response to the received request, the status report based on the indicated type. The UE may transmit the report to an NE, and the NE may update or advance a transmission window accordingly. In the example where the status report is an RLC status report, the RLC status report may include ACK information corresponding to one or more RLC PDUs or RLC SDUs and exclude (e.g., does not include or convey) NACK information corresponding to the one or more RLC PDUs or RLC SDUs. Put another way, the RLC status report may include fields or bits that carry ACK information, but lacks fields or bits that carry NACK information. In some examples, the ACK information may include a sequence number of a first partially received or missing (e.g., not acknowledged) RLC PDU or RLC SDU.

According to one or more implementations, the status report described herein is referred to herein as an ACK-only status report. Unlike some RLC status PDUs, which convey both ACK and NACK information, the status report described herein may be configured to carry only ACK information relating to successfully received RLC PDUs or RLC SDUs. That is, the status report may omit any explicit indication of erroneously received or missing RLC PDUs or RLC SDUs or segments thereof.

In some implementations, the NE (e.g., transmitter side of an RLC entity) may explicitly request the status (e.g., ACK/NACK status) of particular RLC PDUs or particular RLC SDUs from the UE (e.g., peer receiver side of the RLC entity). In contrast to some polling operations, in which the NE may request a full status of a receiving window, the NE may request the status of particular or specific RLC PDUs or RLC SDUs, for example, by indicating corresponding sequence numbers.

In some implementations, a transmitter side of a protocol entity (e.g., an RLC or PDCP protocol entity) may transmit a control PDU that conveys metadata associated with the RLC PDUs or RLC SDUs. For example, the control PDU may include information associated with delay-critical RLC SDUs, application-layer attributes such as packet importance, or PDU set related information. Such information conveyed via the control PDU may enable the receiving entity to optimize its reception and processing operations.

In some other systems, a transmitting side of an RLC entity may increase a frequency of polling to obtain more frequent RLC status reports from a receiving side. Such an approach may increase the amount of feedback received, however, the increased feedback results in a higher signaling overhead. Moreover, such systems may rely on a t-Reassembly timer, which delays the immediate transmission of ACK information and cannot be accounted for through an enhanced polling mechanism. In contrast, the described system supports a new type of RLC status report specifically tailored to address different operational needs, such as advancing transmission windows, requesting status information for specific sequence numbers, requesting retransmission of specific SDUs, and so forth. Such targeted RLC status reports enable more efficient RLC operation without incurring additional signaling overhead.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

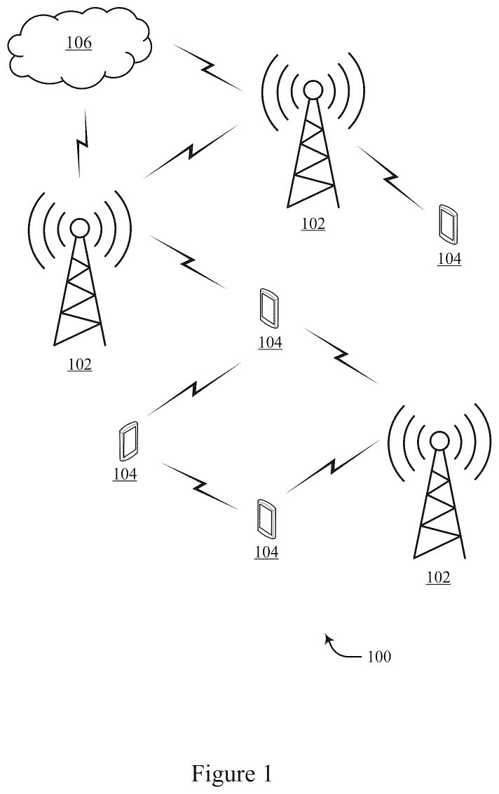

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0,μ=1, μ=2,μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives a request for a status report and a type of status report. For example, the request may be for an RLC status report. The UE 104 generates the status report in response to the received request, the status report based on the indicated type. The UE 104 transmits the report to an NE 102, and the NE 102 updates or advances a transmission window accordingly. In the example where the status report is an RLC status report, the RLC status report includes ACK information corresponding to one or more RLC PDUs or RLC SDUs and excludes NACK information corresponding to the one or more RLC PDUs or RLC SDUs. In some examples, the ACK information includes a sequence number of a first partially received or missing (e.g., not acknowledged) RLC PDU or RLC SDU.

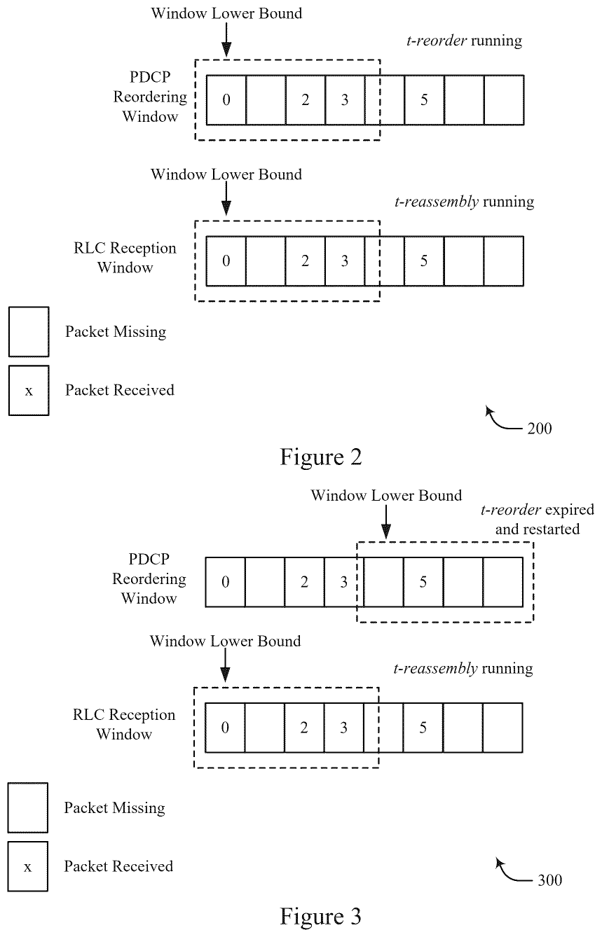

FIGS. 2 and 3 illustrate examples of PDCP and RLC reception windows 200 and PDCP and RLC reception windows 300, respectively, in accordance with aspects of the present disclosure.

PDCP and RLC layers in the user plane protocol stack may function independently from each other. On a receiving side, a PDCP layer may maintain a reordering window to receive PDCP PDUs and transmit the PDCP PDUs to higher layers. In the RLC layer, an RLC receiving entity may maintain a reception window to receive RLC PDUs and transmit the RLC PDUs to higher layers. As shown in FIG. 2, the PDCP reordering window may be controlled by a t-Reordering timer that is configured by radio resource control (RRC). When the t-Reordering timer expires, as shown in FIG. 3, the PDCP reordering window may slide (e.g., adjust, advance, move) forward (e.g., a lower bound of the PDCP reordering window may be updated). If a PDCP receiving entity receives a packet outside of the PDCP reordering window, the PDCP receiving entity may discard the packet.

In an RLC acknowledged mode (AM), an RLC receiving entity may slide (e.g., adjust, advance, move) the RLC reception window when a lowest packet in the RLC reception window (e.g., a packet with a sequence number that matches the lower bound of the RLC AM reception window) has been completely received and an acknowledgment has been sent for that packet. As the PDCP and RLC layers function independently, the respective reception windows and the respective reordering windows may be updated at different times, which may result in communication challenges. In some cases, if the PDCP reordering window moves forward while the RLC window is not updated, the RLC layer may transmit packets to the PDCP layer that are outside of the PDCP reordering window, resulting in the discard of the transmitted packets. By way of example, FIG. 2 depicts the PDCP reordering window and the RLC reception window in an RLC AM, where the lower bounds of both windows may expect a PDU with a sequence number SN=0 (COUNT=0 in case of PDCP, where COUNT=[hyper frame number (HFN), SN]). In FIG. 2, the RLC receiving entity has correctly and fully received packets numbered 0, 2, and 3 and transmitted the packets to the PDCP layer. The PDCP layer also received packets numbered 0, 2, and 3, with the missing packet numbered 1. As such, the PDCP receiving entity may start the t-Reordering timer when the PDCP receiving entity receives packet 2 before packet 1.

While in RLC, the t-Reassembly timer may be started since one or more segments of the packet 1 have not yet been received. When the t-Reordering timer expires, the PDCP reordering window may update its lower bound to a next packet that has not been consecutively received. For example, in FIG. 3, packet 4 is the next packet that has not been consecutively received after the t-Reordering timer expired. As such, the lower bound of the PDCP reordering window may be moved to packet 4, whereas in RLC, the t-Reassembly timer may only trigger a status report based on expiration of the timer, and the reception window may not update unless the status report includes an ACK for packet 1. Since the RLC receiving entity has not yet received packet 1, the RLC receiving entity may still attempt to recover the packet 1 by means of transmissions or retransmissions. Once the RLC receiving entity recovers the packet 1, the RLC receiving entity may the packet 1 may be transmitted to the PDCP receiving entity, which may discard the packet 1 as the packet is outside of the PDCP reordering window. Such redundant transmissions waste resources and may result in unwanted latency on the user plane.

In some implementations, a combined approach may be utilized by introducing a new local timer at an RLC receiver. In some examples, local timer may be started when an RLC SDU is delivered to higher layers out of sequence. Based on expiration of the local timer, a new report may be triggered (e.g., which may also be a legacy status report including dummy ACKs) indicating a PDU as abandoned. The RLC receiver may then update its reception window accordingly. Such mechanisms may be designed to enable the RLC receiver to be in sync with the PDCP reordering window such that the RLC layer may not unnecessarily recover packets that may eventually be discarded at the PDCP layer. Additionally, the RLC transmitter may stop transmission or retransmission of PDUs based on the discard indication received from the PDCP layer. In addition, based on the receiver-based report received from a peer entity, the RLC transmitter may update its transmission window to match the reception window at the receiver side.

In some examples, existing mechanisms may be insufficient to resolve timely RLC retransmission issues and RLC enhancements for timely RLC retransmissions. Such mechanisms exclude enhanced status reporting. In some cases, autonomous retransmission and polling enhancements may be supported, and timely RLC retransmission solutions may cover both autonomous retransmission and polling enhancements configurable by an NE.

As an NE may configure polling enhancements as well as autonomous retransmissions simultaneously, some conditions may be needed to ensure that a channel is not overloaded with polls and/or autonomous retransmissions. Injecting the link with too many autonomous retransmissions may lead to unwanted congestion and delays on the link which may degrade the user experience. Additionally, adding too many polls may result in triggering frequent status reports which may also congest the link and degrade user experience. Some concerns with timer-based autonomous RLC transmissions may be associated with capacity implications. However, such RLC retransmissions may be kept to a minimum provided that RLC ACKs may be provided rapidly. Some RLC status PDUs may be insufficient for rapid acknowledgment because ACK transmissions are held back to avoid false NACKs.

In an RLC AM, the status PDU may include an ACK_SN field indicating implicit acknowledgment of all PDUs before it, and NACK information indicating missing or erroneous SNs. However, the t-Reassembly timer may delay ACK reporting because the timer waits before confirming that a PDU is missing (to avoid false NACKs). As a result, ACKs may also be delayed, preventing rapid advancement of the transmission window.

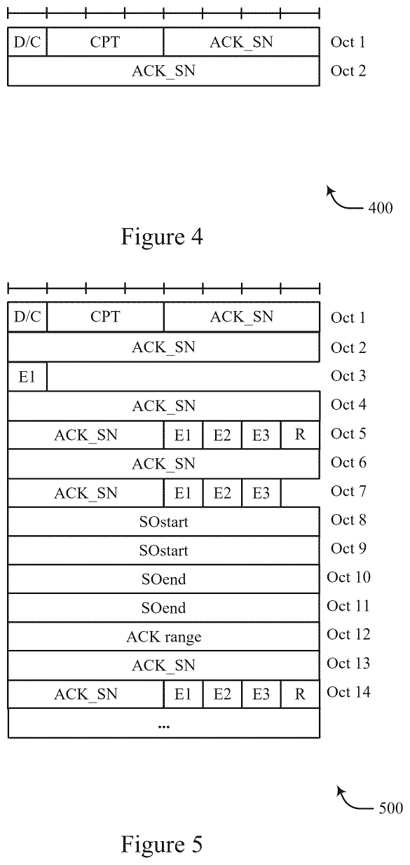

FIG. 4 illustrates an example of a status report 400 in accordance with aspects of the present disclosure. In this example, the status report 400 may be an ACK-only status report that includes ACK information for one or more RLC PDUs or SDUs, but excludes NACK information. For example, the status report 400 may include a data/control (D/C) field (e.g., one bit), a control PDU type (CPT) field (e.g., three bits), and an ACK_SN field (e.g., four bits). The D/C field may indicate whether the status report 400 is for data or control, and the CPT field may indicate the type of the status report 400 (e.g., an ACK-only status report).

In one or more implementations, the status report 400 may be an RLC status report. Unlike conventional RLC status PDUs, which convey both ACK and NACK information, the status report 400 includes only ACK information related to successfully received RLC PDUs or RLC SDUs and excludes (i.e., omits) any explicit indication of erroneously received or missing RLC PDUs or RLC SDUs. The status report 400, being an ACK-only status report, may provide expedited ACK feedback to a transmitting entity of an RLC layer, thereby enabling rapid advancement of a transmission window without initiating retransmission procedures (prematurely). Other RLC status PDUs may be less suitable for this purpose as they operate according to a t-Reassembly timer, which delays the generation and transmission of ACK information to a transmitter in order to avoid premature issuance of NACKs. As a result, delivery of ACK information may be held back until the t-Reassembly timer expires, which in turn may slow down advancement of the transmission window.

In contrast, according to the techniques described herein, a receiving entity (e.g., UE) may receive a request for a status report 400 and a type of the status report. The receiving entity may generate and transmit the status report 400 in response to the received request and based on the indicated type. The status report 400 includes ACK information corresponding to one or more RLC PDUs or RLC SDUs. In some examples, the ACK information includes solely an indication, such as in the ACK_SN field, of a sequence number of the first RLC PDU or RLC SDU that has not yet been fully received (e.g., a first partially received or missing RLC PDU or RLC SDU). When a transmitting entity of an AM RLC mode (e.g., an NE) receives the status report 400, the transmitting entity may interpret the status report 400 as confirmation that all RLC SDUs with sequence numbers less than the sequence number reported in the ACK_SN field have been correctly received by the peer entity. No NACK-related information is included in such a type of status report 400.

In some implementations, the ACK-only status report 400 consists exclusively of a single field, ACK_SN, which explicitly identifies the sequence number of the first not fully received (e.g., partially received or missing) RLC PDU or RLC SDU. Based on receiving the status report 400, the transmitting entity may promptly update and advance its transmission window according to the value of the ACK_SN field, which may result in faster and more efficient window management while minimizing signaling overhead.

In some examples, the status report 400 may be transmitted in addition to a legacy status report, or a normal status PDU, which may include ACK information and NACK information. In such cases, the ACK-only status report 400 may be used for rapid advancement of the transmission window, and the legacy status report may be used for data recovery of lost or missing RLC PDUs or RLC SDUs. In such cases, the ACK-only status report 400 may include just the ACK_SN field, which indicates the sequence number of the first not fully received RLC PDU or RLC SDU, in addition to other legacy fields used to identify an RLC status PDU.

FIG. 5 illustrates an example of a status report 500 in accordance with aspects of the present disclosure. In this example, the status report 500 may be an ACK-only status report that includes ACK information for one or more RLC PDUs or SDUs, but excludes NACK information. For example, the status report 500 may include a D/C field (e.g., one bit), a CPT field (e.g., three bits), and an ACK_SN field (e.g., four bits). The D/C field may indicate whether the PDU is for data or control, and the CPT field may indicate the type of the status report 500.

As described with reference to the status report 400 of FIG. 4, the status report 500 may be an RLC status report that includes ACK information corresponding to one or more RLC PDUs or RLC SDUs but omits NACK information. In some examples, the ACK information includes solely an indication, such as in the ACK_SN field, of a sequence number of the first RLC PDU or RLC SDU that has not yet been fully received (e.g., a first partially received or missing RLC PDU or RLC SDU). In some implementations, the ACK-only status report may include the ACK_SN field and either an ACK_SN bitmap or additional ACK_SN fields indicating non-consecutively acknowledged RLC PDUs or RLC SDUs. That is, the status report 500 may include a bitmap or one or more additional sequence numbers indicating ACK information for one or more non-consecutive RLC PDUs or RLC SDUs. In such cases, the receiving entity may be enabled to provide more granular acknowledgment feedback in cases where received SDUs are not contiguous, while still avoiding overhead and latency associated with explicit NACK signaling. The ACK-only status report 500 may not trigger an RLC retransmission.

In some examples, the transmitter side of an RLC entity may indicate, to a peer receiving entity, to provide the ACK-only status report 500 including the ACK information and excluding NACK information. In some cases, the receiving entity may generate the ACK-only status report 500 irrespective of a t-Reassembly timer. That is, the receiving entity may generate the status report 500 while the t-Reassembly timer is running, The behaviors of the transmitting and receiving entities may not be dictated by the expiration of the t-Reassembly timer. Additionally, or alternatively, the receiving entity may bypass a t-StatusProhibit timer and transmit the status report 500 immediately after the report is generated, instead of transmitting the status report 500 based on the t-StatusProhibit timer, for example, upon expiry of the t-StatusProhibit timer.

In some implementations, the transmitting entity may transmit a request for generation and transmission of the status report 500. In some examples, the transmitting entity may transmit the request via a new RLC control PDU or an RLC PDU header. In another example, the transmitting entity may indicate the request together with polling information. That is, in addition to a polling bit set, the transmitting entity may include another field in an RLC PDU header indicative of the type of status report requested by the transmitting entity (e.g., a legacy status report or an ACK-only status report 500).

In some examples, the transmitting entity may explicitly request a status (e.g., status information) of particular RLC PDUs or RLC SDUs. That is, the request for the status report 500 may include one or more sequence numbers, the one or more sequence numbers indicative of a request for status information corresponding to one or more respective RLC PDUs or respective RLC SDUs associated with the one or more sequence numbers. In contrast with polling operations specified for 5G NR-advanced (NR-A), which requests a full status of a receiving window, the transmitter side may request the status of specific RLC PDUs or RCL SDUs (e.g., identified by the corresponding sequence number). Since the transmitting entity has information of the remaining time of an SDU and some application layer-related information (e.g., importance or priority of the RLC PDUs and RLC SDUs), the transmitting entity has the best knowledge to trigger a request for specific RLC PDUs or RLC SDUs. For example, when the remaining time of an SDU becomes less than a predefined threshold, the transmitting entity may request a status of the SDU from the receiving entity to trigger some quick retransmission for cases in which the PDU or SDU was not yet successfully received. Rather than requesting the status of the entire, complete reception window, the transmitting side may request the status for only some specific sequence numbers. In response to such a request for the status report 500, the receiving entity may generate and transmit the status report 500 for the indicated sequence numbers immediately, irrespective of any RLC related timers (e.g., t-StatusProhibit, t-Reassembly).

In some implementations, the status of an RLC PDU or an RLC SDU (e.g., as indicated in the status report 500) may include one or more of an ACK, a NACK, or an unknown status. An ACK status may indicate that a respective RLC PDU or a respective RLC SDU has been successfully received. A NACK status may indicate that the respective RLC PDU or the respective RLC SDU has not been successfully received (e.g., partially-received). An unknown status may indicate that the t-Reassembly has yet to expire, and as such, the status of the respective RLC PDU or respective RLC PDU or respective RLC SDU is unclear. That is, the unknown status may indicate that the reception of status of the respective RLC PDU or respective RLC SDU cannot yet be confirmed because the t-Reassembly timer has not yet expired. The ACK and NACK statuses are already confirmed states. In some examples, the transmitting entity may behave differently based on the returned status type. For example, a confirmed NACK may trigger an immediate retransmission of the respective RLC PDU or respective RLC SDU, whereas an unknown status may prompt the transmitting side to either defer a retransmission or issue a subsequent selective status request after a predetermined time has elapsed.

In some examples, the transmitting entity may be configured to explicitly request status information for one or more specific RLC PDUs or RLC SDUs from a peer receiving RLC entity. In contrast to a polling procedure specified for 5G NR, in which the transmitting entity requests a complete status report for an entire reception window, the transmitting entity selectively indicates particular RLC PDUs or RLC SDUs of interest, for example by identifying the corresponding sequence numbers. Such a selective status request mechanism leverages the fact that the transmitting entity has additional information concerning the delay status of an RLC SDU, and application-layer information and relevance about specific RLC PDUs and RLC SDUs. For example, the transmitting entity may determine, based on a remaining time of a given RLC SDU or based on its application-layer importance, that an expedited status request is desirable. In some examples, if the remaining time of an RLC SDU falls below a predefined or configured threshold, the transmitting entity may issue a selective status request for that RLC SDU to the receiving entity to promptly ascertain its delivery status and, if necessary, trigger a fast retransmission. Unlike full-window polling, the described mechanism minimizes unnecessary signaling and reduces latency by limiting the request to only the RLC PDUs or RLC SDUs deemed time-critical or higher priority.

In some examples, in response to such a selective status report request, the receiving entity may generate and transmit the status report 500 pertaining only to the requested sequence numbers. In such cases, the receiving entity may transmit the status report 500 immediately once generated, independently of any RLC protocol timers (e.g., t-StatusProhibit or t-Reassembly), which in conventional operation, may otherwise delay status reporting.

In some examples, the status report 500 may include a request for an RLC retransmission of specific RLC PDUs or RLC SDUs identified by a sequence number. Based on receiving such a status report 500, the transmitting entity may refrain from updating its transmission window, but instead immediately trigger the retransmission of the indicated RLC PDUs or RLC SDUs or segments thereof.

Additionally, or alternatively, a new type of retransmission request for a higher layer protocol (e.g., RLC or PDCP layer) may be utilized. The retransmission request may be referred to as an on-demand retransmission request or an on-demand status report (OD-SR). According to some implementations, the OD-SR may be generated irrespective of any protocol-related timers (e.g., t-StatusProhibit or t-Reassembly). If the receiving entity has identified an important RLC PDU or RLC SDU which needs to be delivered to a higher layer quickly, but there are missing SDUs in the reception buffer before the to-be-delivered RLC SDU or RLC SDUs belonging to a same RLC PDU set are missing, the receiving entity may request some time critical retransmissions by transmitting a status report that requests the retransmission of the specific RLC SDUs. In such cases, the receiving entity may be aware of the importance of an RLC PDU or RLC SDU and PDU set information. In contrast to other status reports, which may provide a full status of a reception buffer, the OD-SR may request only the retransmission of specific RLC PDUs or RLC SDUs, which are identified by a sequence number without providing a status of the other RLC PDUs or RLC SDUs in the reception buffer. In some examples, the transmitter side may, upon reception of an OD-SR, refrain from updating its transmission window, but only trigger the retransmission of the indicated RLC PDUs or RLC SDUs.

In some implementations, the described techniques may support a type of control PDU transmitted from a transmitting side to a receiving side of a protocol entity, such as an RLC entity or an PDCP entity. The purpose of such a control PDU is to convey metadata associated with RLC PDUs or RLC SDUs. For example, the metadata may include information associated with delay-critical RLC SDUs, application-layer attributes such as packet importance, or PDU set-related information, thereby enabling the receiving entity to optimize its reception and processing operations. According to some implementations, the control PDU may include information related to a specific PDU or a specific SDU identified by a sequence number. In some examples, the such information may include an importance level indicator and/or an indication of whether delivery of the RLC PDU or the RLC SDU to the higher layer is time-critical.

In some implementations, the control PDU may carry PDU set-related information, such as the sequence numbers corresponding to RLC PDUs or RLS SDUs belonging to a common PDU set or application layer unit. Additionally, or alternatively, the control PDU may include application-layer forward error correction (AL-FEC) related information, such as the total number of PDUs or SDUs within a given PDU set and the number of source and systematic PDUs among them. Based on the information conveyed in the control PDU, the receiving entity may take optimized actions, such as requesting retransmission of one or more missing RLC PDUs or RLC SDUs belonging to the identified PDU Set, or prioritizing the delivery of delay-critical RLC SDUs to the higher layer without waiting for lower-sequence number RLC SDUs that have not been successfully received. Alternatively, the metadata associated with a RLC SDUs or RLC PDUs may be transmitted in a RLC PDU header (e.g., importance of an RLC SDU or PDU set related information is signaled within a field of the RLC PDU header).

In some examples, transmission of the control PDU by the transmitting entity may be triggered by curtained predefined conditions. For example, the transmitting entity may generate and send a control PDU when the remaining time of a given RLC PDU or RLC SDU becomes less than a configured threshold value. In such cases, the control PDU provides the receiving entity with timely metadata that enables more efficient handling of delay-sensitive or application-prioritized traffic. Alternatively, the transmitting entity may transmit the control PDU in advance, for example, with or before a first RLC PDU or RLC SDU of a PDU set.

In some examples, the status report 500 may be a status report providing information on an application layer level (e.g., a PDU set status report). For example, a status report 500 may indicate whether a PDU set has been successfully received at the receiving entity or whether a PDU set is missing or not fully received (e.g., indicating which RLC PDUs or RLC SDUs of a PDU set are missing). In some implementations, the status report 500 may trigger the retransmission of a PDU set or segments of a PDU sets (e.g., missing RLC SDUs or RLC PDUs of a PDU set).

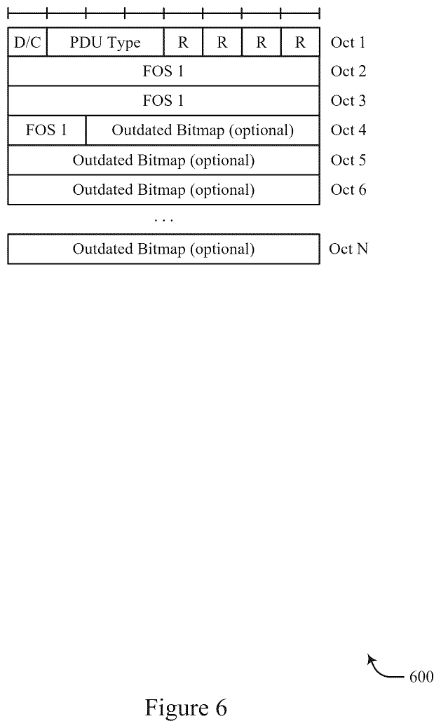

FIG. 6 illustrates an example of a status report 600 in accordance with aspects of the present disclosure. In this example, the status report 600 may be an ACK-only status report that includes ACK information for one or more RLC PDUs or SDUs, but excludes NACK information.

In some examples, the transmitting entity of a protocol entity (e.g., an RLC entity) may consider an RLC PDU or RLC SDU as acknowledged even though a status report is received, the status report indicating that such RLC PDU or RLC SDU is not acknowledged (e.g., NACK information for cases in which the RLC PDU or RLC SDU has been indicated as discarded or outdated (e.g., by the PDCP layer). In some implementations, the transmitting entity has a right to override the ACK or NACK status of an RLC PDU or RLC SDU as indicated in a received status report, such as the status report 400 of FIG. 4 or the status report 500 of FIG. 5, based on a discard indication from the PDCP layer and to update the transmission window accordingly. To avoid a stalling of the transmission window, the transmitting entity may update the transmission window not only based on the reception of a status report from the receiving side, but also based on a discard indication received from a higher layer (e.g., a PDCP layer).

In some examples, a UE transmitting side may trigger transmission of a notification (i.e., report) to the receiver side about RLC SDUs which have not been considered as ACKed based on a discard indication. To ensure that the receiving and transmitting windows are synchronized, the notification may be triggered once the transmitting side overrides a status report received from the receiving side. In such cases, an RLC transmitter may trigger a new report (e.g., transmitter-based control PDU) to its peer entity, the report including additional information with respect to the RLC PDUs or RLC SDUs for which the ACK or NACK status has been changed by the RLC transmitting entity, based on a discard indication. The discarded packets may refer to RLC PDUs associated with PDCP SDUs whose discardTimer or discardTimerForLowImportance has expired.

In some implementations, the notification may include information with respect to a number of consecutive discarded or outdated RLC PDUs or RLC SDUs. As such, an RLC receiver, upon reception of such a report, may proactively skip starting a t-RxDiscard timer for the packets indicated as outdated or discarded. Alternatively, or alternatively, the notification may include information of the discarded or outdated RLC PDUs associated with a PDU set (e.g., in the case where pdu-SetDiscard is configured and the discard timer for one or more PDUs of a PDU set expires. The status report 600 is an example of a format of such a notification (i.e., report).

In the status report 600, a first outdated sequence number (FOS) refers to a smallest RLC sequence number of the sequence numbers of the packets categorized as outdated by the RLC transmitted. The outdated bitmap may indicate a bitmap for all of the following sequence numbers that are outdated, where a bit value of ‘0’ indicates a sequence number as not outdated and a bit value of ‘1’indicates that the sequence number is outdated, for example.

In some implementations, control PDUs of a higher layer protocol, such as the RLC layer or the PDCP layer, may be treated during logical channel prioritization (LCP) As delay-critical data. In order to ensure a timely delivery of a control PDU such as an RLC status report or a PDCP status report, the UE may prioritize such information (e.g., similar to a medium access control (MAC) control entity (MAC-CE)), during an LCP procedure. In some examples, the UE may treat control PDUs as delay-critical data and accordingly, may use a higher logical channel (LCH) priority during the LCP procedure. An additional priority may be configured for an LCH, which may be applied when a control PDU is among the data available for transmission. In some examples, the UE may check whether there is an RLC PDU or control PDU for an LCH in a transmission buffer available for transmission before a first round of LCP. In case there is an RLC PDU or a control PDU pending for transmission, the UE may apply an additional, higher priority to the LCH during the LCP. In some examples, the additional priority may be configured by a gNB or fixed in standards. Additionally, or alternatively, the UE or a MAC layer entity may determine whether, after the first round of LCP, there are RLC or PDCP control PDUs pending for transmission for an LCH. If there are no RLC or PDCP control PDUs left for transmission (after the first round of LCP), the UE or the MAC layer entity may use legacy LCH priority during a second round of the LCP.

In some examples, control PDUs of higher layer protocols such as the RLC or PDCP layer, may be treated as delay-critical data during a logical channel prioritization (LCP) procedure. To ensure timely transmission of such control PDUs, for example, an RLC or PDCP status report, a UE may assign priorities to such control information in a manner similar to that applied for MAC-CEs during the LCP procedure. In some implementations, the UE may identify the presence of a control PDU associated with an RLC or PDCP entity in a transmission buffer prior to execution of a first round of the LCP procedure. Based on detecting such a control PDU, the UE may apply an increased priority to the corresponding LCH relative to its configured priority. The increased or additional LCH priority may be predefined in a communication standard, or configured by an NE.

In some implementations, following completion of the first round of the LCP procedure, the UE or its MAC layer entity may determine whether any RLC or PDCP control PDUs remain pending for transmission on the corresponding LCH. If no such control PDUs remain after the first round of the LCP, the UE may revert the LCH to its configured legacy priority for subsequent rounds of LCP. By dynamically adapting the LCH priority in the presence of RLC or PDCU control PDUs, the proposed mechanism may ensure timely delivery of delay-critical control information while restoring normal prioritization once the delay-critical data has been scheduled, thereby preserving fairness of such prioritization procedures.

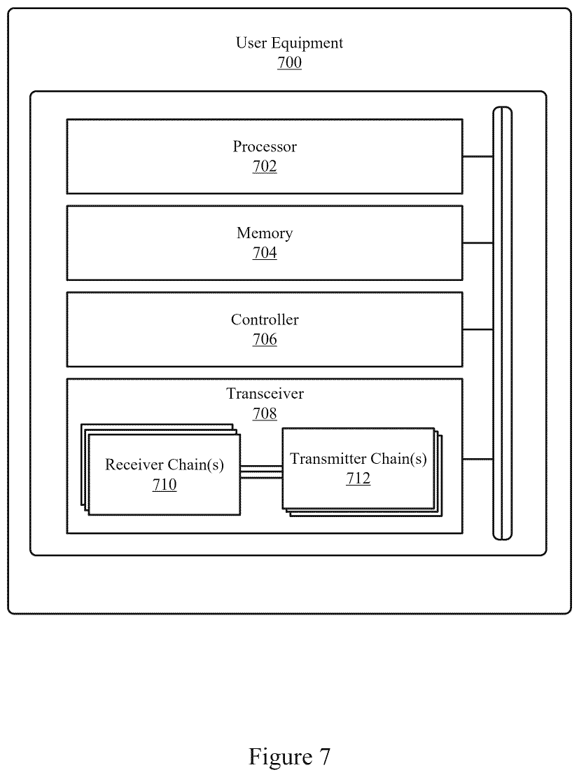

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving a request for a status report and a type of the status report; generating the status report in response to the received request, where the status report is based on the type of the status report; and transmitting the status report.

Additionally, the UE 700 may be configured to support any one or combination of where the type of the status report is an RLC status report, and where the RLC status report includes ACK information and excludes NACK information, and where the ACK information corresponds to one or more RLC PDUs or RLC SDUs; where the ACK information includes a sequence number indicating a first partially received or missing RLC PDU or RLC SDU; where the RLC status report further includes a bitmap or one or more additional sequence numbers indicating ACK information for one or more non-consecutive RLC PDUs or RLC SDUs; where the received request for the status report includes one or more sequence numbers, the one or more sequence numbers indicative of a request for status information corresponding to one or more respective RLC PDUs or respective RLC SDUs associated with the one or more sequence numbers; where status information corresponding to a respective RLC PDU or a respective RLC SDU includes one or more of an ACK, a NACK, or unknown; where the RLC status report includes a request for a retransmission of the one or more respective RLC PDUs or respective RLC SDUs; where the request is received via an RLC control PCU or an RLC PDU header; or where the status report is generated based on a timer, where the status report is transmitted irrespective of an expiration of the timer, and where the timer is a t-reassembly timer.

Additionally, or alternatively, the UE 700 may support at least one memory (e.g., the memory 704) and at least one processor (e.g., the processor 702) coupled with the at least one memory and configured to cause the UE to receive a request for a status report and a type of the status report; generate the status report in response to the received request, where the status report is based on the type of the status report; and transmit the status report.

Additionally, the UE 700 may be configured to support any one or combination of where the type of the status report is an RLC status report, and where the RLC status report includes ACK information and excludes NACK information, and where the ACK information corresponds to one or more RLC PDUs or RLC SDUs; where the ACK information includes a sequence number indicating a first partially received or missing RLC PDU or RLC SDU; where the RLC status report further includes a bitmap or one or more additional sequence numbers indicating ACK information for one or more non-consecutive RLC PDUs or RLC SDUs; where the received request for the status report includes one or more sequence numbers, the one or more sequence numbers indicative of a request for status information corresponding to one or more respective RLC PDUs or respective RLC SDUs associated with the one or more sequence numbers; where status information corresponding to a respective RLC PDU or a respective RLC SDU includes one or more of an ACK, a NACK, or unknown; where the RLC status report includes a request for a retransmission of the one or more respective RLC PDUs or respective RLC SDUs; where the request is received via an RLC control PCU or an RLC PDU header; or where the status report is generated based on a timer, where the status report is transmitted irrespective of an expiration of the timer, and where the timer is a t-reassembly timer.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

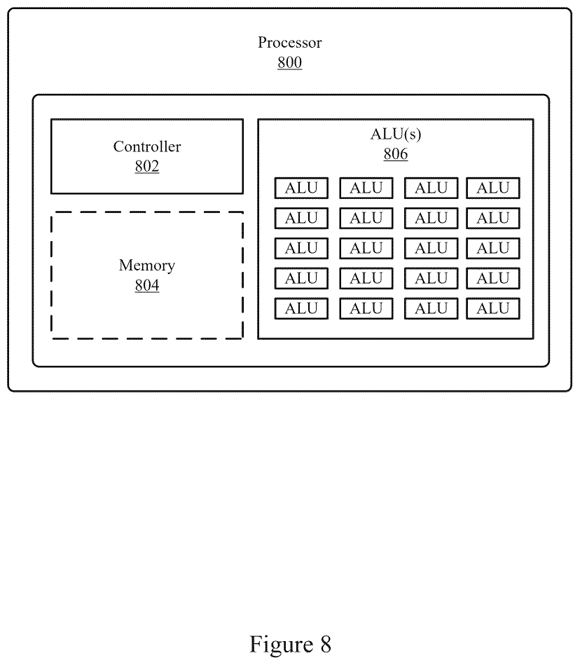

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive a request for a status report and a type of the status report; generate the status report in response to the received request, where the status report is based on the type of the status report; and transmit the status report.

Additionally, the processor 800 may be configured to or operable to support any one or combination of where the type of the status report is an RLC status report, and where the RLC status report includes ACK information and excludes NACK information, and where the ACK information corresponds to one or more RLC PDUs or RLC SDUs; where the ACK information includes a sequence number indicating a first partially received or missing RLC PDU or RLC SDU; where the RLC status report further includes a bitmap or one or more additional sequence numbers indicating ACK information for one or more non-consecutive RLC PDUs or RLC SDUs; where the received request for the status report includes one or more sequence numbers, the one or more sequence numbers indicative of a request for status information corresponding to one or more respective RLC PDUs or respective RLC SDUs associated with the one or more sequence numbers; where status information corresponding to a respective RLC PDU or a respective RLC SDU includes one or more of an ACK, a NACK, or unknown; where the RLC status report includes a request for a retransmission of the one or more respective RLC PDUs or respective RLC SDUs; where the request is received via an RLC control PCU or an RLC PDU header; or where the status report is generated based on a timer, where the status report is transmitted irrespective of an expiration of the timer, and where the timer is a t-reassembly timer.

Additionally, or alternatively, the processor 800 may be configured to or operable to support at least one controller (e.g., the controller 802) coupled with at least one memory (e.g., the memory 804) and configured to cause the processor to transmit a request for a status report and a type of the status report; and receive the status report, where the status report is based on the type of the status report.

Additionally, or alternatively, the processor 800 may be configured to or operable to support any one or combination of where the type of the status report is an RLC status report, where the RLC status report includes ACK information and excludes NACK information, and where the ACK information corresponds to one or more RLC PDUs or RLC SDUs; where the ACK information includes a sequence number indicating a first partially received or missing RLC PDU or RLC SDU; updating a transmission window based on the sequence number indicated in the ACK information; where the RLC status report further includes a bitmap or one or more additional sequence numbers indicating ACK information for one or more non-consecutive RLC PDUs or RLC SDUs; where the transmitted request for the status report includes one or more sequence numbers, the one or more sequence numbers indicative of a request for status information corresponding to one or more respective RLC PDUs or respective RLC SDUs associated with the one or more sequence numbers; where the RLC status report includes a request for a retransmission of the one or more respective RLC PDUs or respective RLC SDUs; triggering the retransmission of the one or more respective RLC PDUs or respective RLC SDUs based on the request; or where respective status information corresponding to a respective RLC PDU or a respective RLC SDU includes one or more of an ACK, a NACK, or unknown.

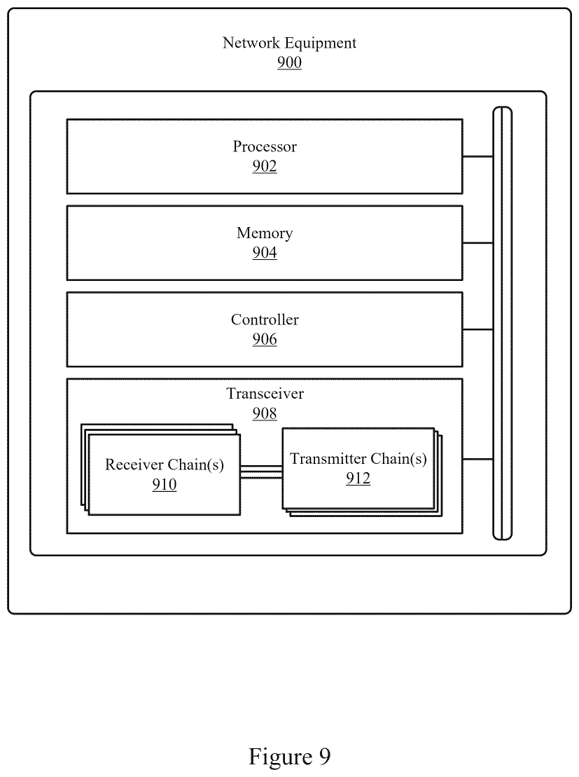

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting a request for a status report and a type of the status report; and receiving the status report, where the status report is based on the type of the status report.

Additionally, the NE 900 may be configured to or operable to support any one or combination of where the type of the status report is an RLC status report, where the RLC status report includes ACK information and excludes NACK information, and where the ACK information corresponds to one or more RLC PDUs or RLC SDUs; where the ACK information includes a sequence number indicating a first partially received or missing RLC PDU or RLC SDU; updating a transmission window based on the sequence number indicated in the ACK information; where the RLC status report further includes a bitmap or one or more additional sequence numbers indicating ACK information for one or more non-consecutive RLC PDUs or RLC SDUs; where the transmitted request for the status report includes one or more sequence numbers, the one or more sequence numbers indicative of a request for status information corresponding to one or more respective RLC PDUs or respective RLC SDUs associated with the one or more sequence numbers; where the RLC status report includes a request for a retransmission of the one or more respective RLC PDUs or respective RLC SDUs; triggering the retransmission of the one or more respective RLC PDUs or respective RLC SDUs based on the request; or where respective status information corresponding to a respective RLC PDU or a respective RLC SDU includes one or more of an ACK, a NACK, or unknown.

Additionally, or alternatively, the NE 900 may support at least one memory (e.g., the memory 904) and at least one processor (e.g., the processor 902) coupled with the at least one memory and configured to cause the NE to transmit a request for a status report and a type of the status report; and receive the status report, where the status report is based on the type of the status report.

Additionally, the NE 900 may be configured to support any one or combination of where the type of the status report is an RLC status report, where the RLC status report includes ACK information and excludes NACK information, and where the ACK information corresponds to one or more RLC PDUs or RLC SDUs; where the ACK information includes a sequence number indicating a first partially received or missing RLC PDU or RLC SDU; updating a transmission window based on the sequence number indicated in the ACK information; where the RLC status report further includes a bitmap or one or more additional sequence numbers indicating ACK information for one or more non-consecutive RLC PDUs or RLC SDUs; where the transmitted request for the status report includes one or more sequence numbers, the one or more sequence numbers indicative of a request for status information corresponding to one or more respective RLC PDUs or respective RLC SDUs associated with the one or more sequence numbers; where the RLC status report includes a request for a retransmission of the one or more respective RLC PDUs or respective RLC SDUs; triggering the retransmission of the one or more respective RLC PDUs or respective RLC SDUs based on the request; or where respective status information corresponding to a respective RLC PDU or a respective RLC SDU includes one or more of an ACK, a NACK, or unknown.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

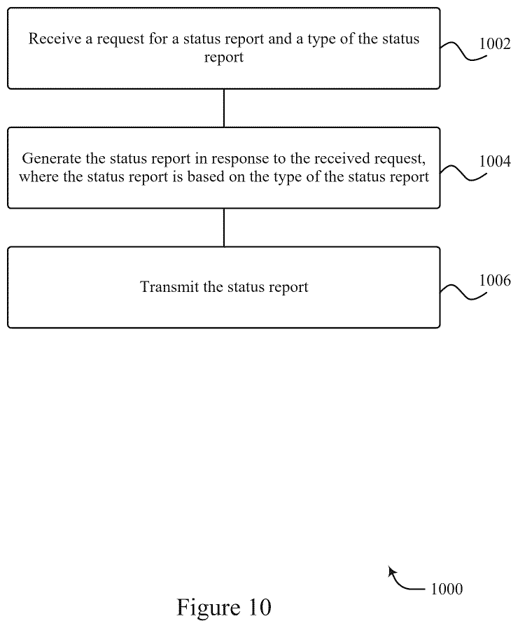

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving a request for a status report and a type of the status report. The operations of 1002 may be performed in accordance with examples as described herein. In some implementations, aspects of the operations of 1002 may be performed by a UE as described with reference to FIG. 7.

At 1004, the method may include generating the status report in response to the received request, where the status report is based on the type of the status report. The operations of 1004 may be performed in accordance with examples as described herein. In some implementations, aspects of the operations of 1004 may be performed by a UE as described with reference to FIG. 7.

At 1006, the method may include transmitting the status report. The operations of 1006 may be performed in accordance with examples as described herein. In some implementations, aspects of the operations of 1006 may be performed a UE as described with reference to FIG. 7.

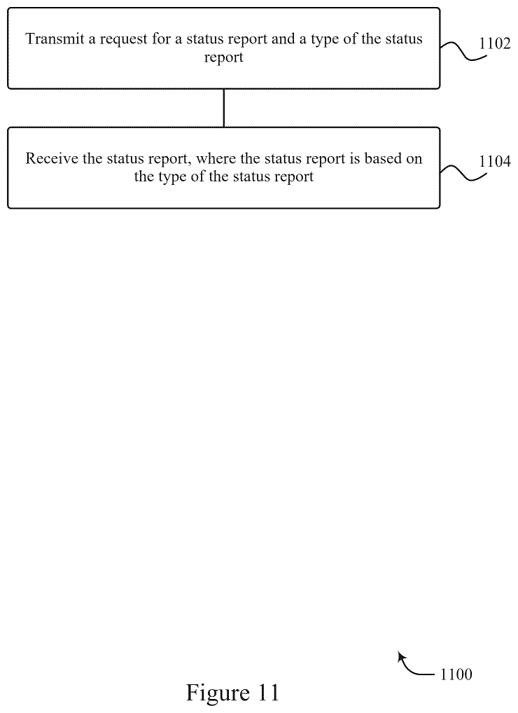

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a request for a status report and a type of the status report. The operations of 1102 may be performed in accordance with examples as described herein. In some implementations, aspects of the operations of 1102 may be performed by an NE as described with reference to FIG. 9.

At 1104, the method may include receiving the status report, where the status report is based on the type of the status report. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive a request for a status report and a type of the status report;
generate the status report in response to the received request, wherein the status report is based at least in part on the type of the status report; and
transmit the status report.

2. The UE of claim 1, wherein the type of the status report is a radio link control (RLC) status report, and wherein the RLC status report includes acknowledgment (ACK) information and excludes negative acknowledgment (NACK) information, and wherein the ACK information corresponds to one or more RLC protocol data units (PDUs) or RLC service data units (SDUs).

3. The UE of claim 2, wherein the ACK information comprises a sequence number indicating a first partially received or missing RLC PDU or RLC SDU.

4. The UE of claim 3, wherein the RLC status report further comprises a bitmap or one or more additional sequence numbers indicating ACK information for one or more non-consecutive RLC PDUs or RLC SDUs.

5. The UE of claim 2, wherein the received request for the status report comprises one or more sequence numbers, the one or more sequence numbers indicative of a request for status information corresponding to one or more respective RLC PDUs or respective RLC SDUs associated with the one or more sequence numbers.

6. The UE of claim 5, wherein respective status information corresponding to a respective RLC PDU or a respective RLC SDU includes one or more of an acknowledgment (ACK), a negative acknowledgment (NACK), or unknown.

7. The UE of claim 5, wherein the RLC status report comprises a request for a retransmission of the one or more respective RLC PDUs or respective RLC SDUs.

8. The UE of claim 1, wherein the request is received via a radio link control (RLC) control protocol data unit (PDU) or an RLC PDU header.

9. The UE of claim 1, wherein the status report is generated based at least in part on a timer, wherein the status report is transmitted irrespective of an expiration of the timer, and wherein the timer is a t-reassembly timer.

10. A network equipment (NE) for wireless communication, comprising:
at least one memory; and
at least one processor coupled with the at least one memory and operable to cause the NE to:
transmit a request for a status report and a type of the status report; and
receive the status report, wherein the status report is based at least in part on the type of the status report.

11. The NE of claim 10, wherein the type of the status report is a radio link control (RLC) status report, wherein the RLC status report includes acknowledgment (ACK) information and excludes negative acknowledgment (NACK) information, and wherein the ACK information corresponds to one or more RLC protocol data units (PDUs) or RLC service data units (SDUs).

12. The NE of claim 11, wherein the ACK information comprises a sequence number indicating a first partially received or missing RLC PDU or RLC SDU.

13. The NE of claim 12, wherein the at least one processor is further operable to cause the NE to update a transmission window based at least in part on the sequence number indicated in the ACK information.

14. The NE of claim 12, wherein the RLC status report further comprises a bitmap or one or more additional sequence numbers indicating ACK information for one or more non-consecutive RLC PDUs or RLC SDUs.

15. The NE of claim 11, wherein the transmitted request for the status report comprises one or more sequence numbers, the one or more sequence numbers indicative of a request for status information corresponding to one or more respective RLC PDUs or respective RLC SDUs associated with the one or more sequence numbers.

16. The NE of claim 15, wherein the RLC status report comprises a request for a retransmission of the one or more respective RLC PDUs or respective RLC SDUs.

17. The NE of claim 16, wherein the at least one processor is further operable to cause the NE to trigger the retransmission of the one or more respective RLC PDUs or respective RLC SDUs based at least in part on the request.

18. The NE of claim 15, wherein respective status information corresponding to a respective RLC PDU or a respective RLC SDU includes one or more of an acknowledgment (ACK), a negative acknowledgment (NACK), or unknown.

19. A method performed by a user equipment (UE), the method comprising:
receiving a request for a status report and a type of the status report;
generating the status report in response to the received request, wherein the status report is based at least in part on the type of the status report; and
transmitting the status report.

20. A method performed by a network equipment (NE), the method comprising:
transmitting a request for a status report and a type of the status report; and
receiving the status report, wherein the status report is based at least in part on the type of the status report.
